(19) United States
(12) Patent Application Publication
(10) Pub. No.: US 2017/0021418 A1
(43) Pub. Date: Jan. 26, 2017

(54) ADDITIVE MANUFACTURING WITH PRE-HEATING

(71) Applicant: Applied Materials, Inc., Santa Clara, CA (US)

(72) Inventors: Hou T. Ng, Campbell, CA (US); Bharath Swaminathan, San Jose, CA (US); Nag B. Patibandla, Pleasanton, CA (US); Ajey M. Joshi, San Jose, CA (US); Ashavani Kumar, Sunnyvale, CA (US); Eric Ng, Mountain View, CA (US); Bernard Frey, Livermore, CA (US); Kasiraman Krishnan, Milpitas, CA (US)

(21) Appl. No.: 15/213,267

(22) Filed: Jul. 18, 2016

Related U.S. Application Data
(60) Provisional application No. 62/194,768, filed on Jul. 20, 2015.
(60) Provisional application No. 62/258,938, filed on Nov. 23, 2015.

(51) Int. Cl. B22F 3/105; B28B 1/00; B33Y 10/00; B33Y 30/00; C04B 35/64; B23K 15/00; B23K 26/342; B23K 26/70; H05B 3/00; B29C 67/00; B33Y 40/00

(52) U.S. Cl. CPC B22F 3/1055; B29C 67/0077; B29C 67/0085; B29C 67/0092; B28B 1/001; B33Y 10/00; B33Y 30/00; B33Y 40/00; B23K 15/0086; B23K 26/342; B23K 26/702; H05B 3/0061; H05B 3/0057; C04B 35/64; B29K 2105/251

(57) ABSTRACT

An additive manufacturing system includes a platen having a top surface to support an object being manufactured, a dispenser to deliver a plurality of successive layers of feed material over the platen, an energy source positioned above the platen to direct a beam to fuse at least some of an outermost layer of feed material, and a plurality of lamps disposed above the platen and around the energy source to radiatively heat the outermost layer of feed material.

### CROSS-REFERENCE TO RELATED APPLICATIONS

This application is a claims priority to U.S. Provisional Application Ser. No. 62/194,768, filed on Jul. 20, 2015, and to U.S. Provisional Application Ser. No. 62/258,938, filed on Nov. 23, 2015, the entire disclosures of which are incorporated herein by reference.

### TECHNICAL FIELD

This invention relates to additive manufacturing, also referred to as 3D printing.

### BACKGROUND

Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood, plastic or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g. stereolithography (SLA).

Sintering is a process of fusing small grains, e.g., powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase. As the sintering temperature does not have to reach the melting point of the material, sintering is often used for materials with high melting points such as tungsten and molybdenum.

Both sintering and melting can be used in additive manufacturing. The material being used determines which process occurs. An amorphous solid, such as acrylonitrile butadiene styrene (ABS), is actually a supercooled viscous liquid, and does not actually melt; as melting involves a phase transition from a solid to a liquid state. Thus, selective laser sintering (SLS) is the relevant process for ABS, while selective laser melting (SLM) is used for crystalline and semi-crystalline materials such as nylon and metals, which have a discrete melting/freezing temperature and undergo melting during the SLM process.

Conventional systems that use a laser beam as the energy source for sintering or melting a powdered material typically direct the laser beam on a selected point in a layer of the powdered material and selectively raster scan the laser beam to locations across the layer. Once all the selected locations on the first layer are sintered or melted, a new layer of powdered material is deposited on top of the completed layer and the process is repeated layer by layer until the desired object is produced.

An electron beam can also be used as the energy source to cause sintering or melting in a material. Once again, the electron beam is raster scanned across the layer to complete the processing of a particular layer.

### SUMMARY

In one aspect, an additive manufacturing system includes a platen having a top surface to support an object being manufactured, a dispenser to deliver a plurality of successive layers of feed material over the platen, an energy source positioned above the platen to direct a beam to fuse at least some of an outermost layer of feed material, and a plurality of lamps disposed above the platen and around the energy source to radiatively heat the outermost layer of feed material.

Implementations may include one or more of the following features. The energy source may include a laser or an ion source. The plurality of lamps may be held on a rotatable support. The plurality of lamps may be positioned equidistant from a center axis through the platen. The plurality of lamps may be positioned at equal angular intervals around the center axis.

A heater may heat the feed material prior to depositing the layer of feed material. The feed material may be a powder, and the heater may be configured to raise the feed material to first temperature that is above room temperature but below a temperature at which the powder becomes tacky.

An actuation system may move the beam in two perpendicular directions relative to the platen. The actuation system may include a linear actuator configured to move energy source in at least one of the two perpendicular directions. The actuation system may include a linear actuator configured to move the platen in at least one of the two perpendicular directions. The actuation system may be configured to deflect the beam in at least one of the two perpendicular directions. The energy source may include a laser and the actuation system may include a mirror galvanometer to deflect a laser beam from the laser.

The actuation system may be configured to adjust a depth of focus of the beam. The actuation system may include movable optical components to adjust the depth of focus. The actuation system may include a linear actuator to move the energy source in a directions perpendicular to the surface of the platen.

In another aspect, an additive manufacturing system includes a platen having a top surface to support an object being manufactured, a dispenser to deliver a plurality of successive layers of feed material over the platen, a first heater configured to heat the feed material to a free flow temperature before the feed material is dispensed by the dispenser, and an energy source to fuse at least some of an outermost layer of feed material over the platen.

Implementations may include one or more of the following features. The dispenser may include a reservoir adjacent the platen. The first heater may include a heat lamp positioned above the reservoir. The first heater may include a resistive heater embedded in a support plate of the reservoir. The first heater may be configured to heat the feed material in the dispenser without applying heat to the layer of feed material dispensed over the platen. The dispenser may include two reservoirs positioned on opposite sides of the platen.

A second heater may be configured to heat substantially all of the outermost layer to a caking temperature. The second heater may include a plurality of heat lamps positioned around the energy source. The plurality of heat lamps may be held on a rotatable support. The energy source may include a laser or an ion source.

In another aspect, a method of additive manufacturing includes, before dispensing a feed material in a layer over platen, raising a temperature of the feed material to a first temperature that is above room temperature and below a second temperature at which the feed material becomes tacky, dispensing the feed material at the first temperature in a layer over the platen, after dispensing the feed material over the platen, raising the temperature of substantially all of the layer of feed material to a third temperature that is greater than the first temperature but below a fourth temperature at which the feed material fuses, and selectively raising the temperature of portions of the layer of feed material to a fifth temperature that is equal or greater than the fourth temperature.

Implementations may include one or more of the following features. The third temperature may be greater than the second temperature. Selectively raising the temperature of portions of the layer of feed material to the fifth temperature may be performed with a laser or ion source. Raising the temperature of substantially all of the layer of feed material to a third temperature may be performed with a plurality of heat lamps positioned around the laser or ion source. The plurality of heat lamps may orbit around the laser or ion source.

Raising the temperature of the feed material to the first temperature may include raising the temperature of the feed material while the feed material is in a reservoir. Raising the temperature of the feed material while the feed material is in a reservoir may include heating the feed material with a resistive heater embedded in a support plate of the reservoir. Raising the temperature of the feed material while the feed material is in a reservoir may include heating the feed material with a heat lamp positioned over the reservoir. The feed material may be a powder and the fourth temperature may be a sintering temperature.

Implementations may include one or more of the following advantages. Arranging heat lamps around scanning beam heat source, such as a laser, permits heating of the entire layer of feed material without interference by the scanning beam heat source. Rotating the heat lamps can improve temperature uniformity of the outer layer of feed material. By controlling the depth of focus of a laser beam that impinges on the top surface of the deposited feed material, the resolution of the sintering process can be varied. Further, controlling the depth of focus can control the spot size, and thus the energy transferred per unit area, which can permit improvement of the scan rate of the laser beam and thus improve throughput.

The details of one or more embodiments of the invention are set forth in the accompanying drawings and the description below. Other aspects, features and advantages of the invention will be apparent from the description and drawings, and from the claims.

### DESCRIPTION OF DRAWINGS

FIG. 1 is a schematic side view of an additive manufacturing system.

FIG. 2 is a schematic top view of an additive manufacturing system

### DETAILED DESCRIPTION

An additive manufacturing process can involve dispensing a layer of feed material, for example, a powder, on a platen or a previously deposited layer, followed by a method to fuse portions of the layer of feed material. An energy source heats up the feed material and causes it to solidify, e.g., to cause the powder to fuse. However, temperature fluctuations caused by the point-by-point sintering or melting of a powdered material can create thermal stresses within the printed object. In addition, it takes time to scan the beam across the layer of feed material.

In an additive manufacturing process, the feed material can be heated prior to being deposited over the platen. This can reduce the amount of power needed by the scanning beam to cause a particular voxel to solidify. This permits the beam to move more quickly across the layer, and thus can increase throughput. In addition, this can reduce the size of the temperature fluctuations, and thus reduce thermal stress and improve material properties. Thus, if the feed material starts at an initial temperature, e.g., room temperature, it can be raised to a first temperature before being dispensed.

However, above some temperatures, a powder may become tacky and thus viscous. This can interfere with proper depositing of the layer or subsequent layers. Thus, for some additive manufacturing processes, it is desirable to raise the temperature of the powder, but not above a second threshold temperature at which the powder becomes tacky or viscous. In the context of metal powders, “tacky” can indicate a small amount of necking or sintering, e.g., some percentage of particles become sintered at points of contact but without significant morphology change in the particles.

Once the feed material is deposited on the platen, the temperature of the top layer of the feed material can be further raised, e.g., by radiative energy transfer from heat lamps, to a third temperature that is closer but still below a fourth temperature at which the feed material will fuse, e.g., sinter or melt. In some implementation, this higher third temperature is still lower than the threshold temperature at which the powder becomes tacky or viscous, i.e., the second temperature. In some implementations, this higher third temperature is above the threshold second temperature at which the powder becomes tacky or viscous, but below a “caking temperature” at which the powder undergoes sintering at points of contact but remains substantially porous and does not experience significant densification, e.g., achieves a cake-like consistency. In some implementations, this higher third temperature is above the caking temperature but still below a fusing temperature at which feed material fuses, e.g., sinter or melts to form a solid mass with lower porosity or reduced gaps between particles.

Finally, the temperature of the desired portions of the top layer of the feed material can be raised to caking temperature or to fusing temperature by the beam that scans over the surface of the deposited feed material.

It is beneficial for the temperature of the top surface of the deposited feed material to be uniform prior to scanning by the beam, as this improves reliability that the pattern of fused voxels will correspond to the desired pattern. Preheating of the feed material reduces the energy needed by the heat lamps and can improve spatial temperature uniformity of the layer. Preheating of the feed material by the heat lamps reduces the energy needed for the beam to fuse a particular spot, and therefore can improve throughput and reduce temperature fluctuations.

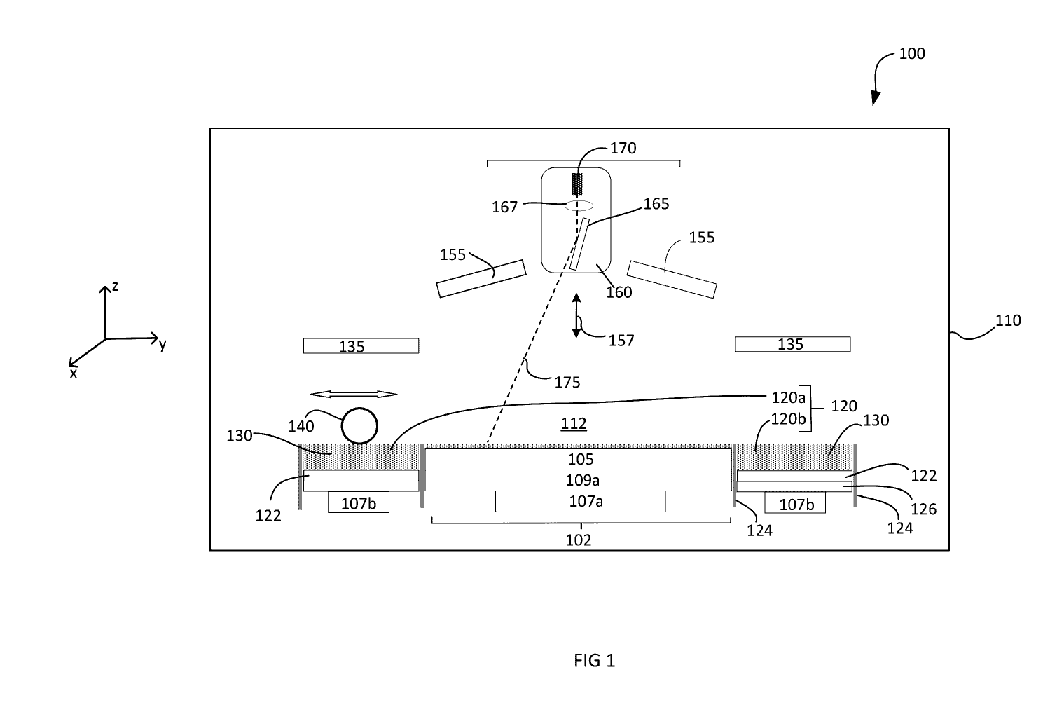

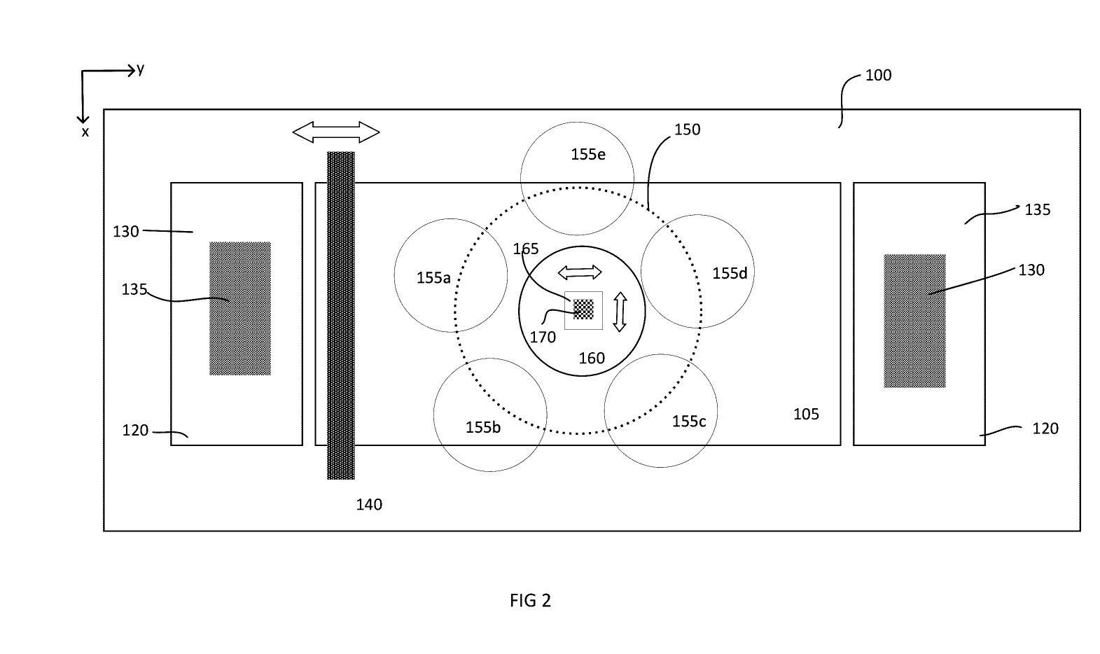

FIG. 1 and FIG. 2 are side and top views, respectively, of an embodiment of an additive manufacturing system 100. The additive manufacturing system 100 includes a support 102 to hold the object being fabricated, a feed material delivery system to deliver a layer of feed material over the support 102, a first heat source 155, such as an array of heat lamps, configured to heat the entire layer of feed material, and a second heat source 160 configured to generate a beam 175 to scan across the layer of feed material and selectively heat portions of the layer of feed material sufficiently to solidify the feed material.

Optionally, some parts of the additive manufacturing system 100, e.g., components of one or more of the support, dispenser, first heat source 155 and second heat source 160, can be enclosed by a housing 110. The housing 110 can, for example, allow a vacuum environment to be maintained in a chamber 112 inside the housing, e.g., pressures at about 1 Torr or below. Alternatively the interior of the chamber 112 can be a substantially pure gas, e.g., a gas that has been filtered to remove particulates, or the chamber can be vented to atmosphere. Pure gas can constitute inert gases such as argon, nitrogen, xenon, and mixed inert gases.

The support 102 can include a platen 105 that is vertically movable, e.g., by a linear actuator connected to the platen 105 by a piston rod 107a. After processing of each layer, i.e., solidification of desired portions of the layer, the support 102 can be lowered by a distance equal to the thickness of the layer of material just added to the object being fabricated.

In addition, the support can include a heater, such as a resistive heater embedded in the platen 105 or a lower lamp array 109a below the platen, to heat the platen and the feed material 130 that has been deposited on the platen 105.

The additive manufacturing system 100 includes feed material delivery system to deliver a layer of feed material, e.g., a powder, over a platen 105, e.g., on the platen or onto an underlying layer on the platen.

The feed material can be a dry powder of metallic, ceramic, or plastic particles, metallic, ceramic, or plastic powders in liquid suspension, or a slurry suspension of a material. For example, for a dispenser that uses a piezoelectric printhead, the feed material would typically be particles in a liquid suspension. In the case of a suspension, the liquid component can be evaporated prior to fusing.

Examples of metallic particles include titanium, stainless steel, nickel, cobalt, chromium, vanadium and various alloys of these metals. Examples of ceramic materials include metal oxide, such as ceria, alumina, silica, aluminum nitride, silicon nitride, silicon carbide, or a combination of these materials. Examples of plastics can include ABS, nylon, polyetherimide, polyetheretherketone (PEEK), polyetherketoneketone (PEKK), polyurethane, acrylate, epoxy, polyetherimide, polyamides, polycarbonates or polyester.

The feed material delivery system delivers the feed material from a reservoir to the platen, where it may be solidified. For example, in the case of a powder, the feed delivery system can dispense a layer of power across the support, where the powder will be fused.

In the embodiment shown in FIGS. 1 and 2, the feed material 130 is held in a reservoir 120 adjacent the support 102. In the implementation shown in FIGS. 1 and 2, the system 100 includes two reservoirs 120a, 120b positioned on opposite sides of the platen 105, but the system could include just one reservoir.

Each reservoir 120 can be defined by a vertically movable support plate 122 surrounded by side walls 124. The mechanism for displacing the support plate 122 can be a linear actuator connected to the support plate 122 by a piston rod 107b. The feed material 130 can be pushed from the reservoir 120 across the platen 105.

This can be done by moving a reservoir 120 up (+z direction), e.g., by a distance that is sufficient to provide an amount of powder above the wall 124 sufficient to coat the platen 105 or underlying layer. Then a device 140, such as roller or a blade, pushes the feed material off the support plate 122 and across the platen 105.

Where the system 100 includes two reservoirs 120a, 120b positioned on opposite sides of the platen, the material can be dispensed from alternating reservoirs for alternating layers. For example, the roller or blade 140 can be moved from the reservoir 120a at the left end of the platen 105 to the reservoir 120b at the right end of the platen 105, and in the process spreading a layer of the feed material 130 from the reservoir 120a over the platen 105. After that layer has been processed, another layer of powder can be dispensed by moving the roller or blade 140 can be moved from the reservoir 120b at the right end of the platen 105 to the reservoir 120a at the left end of the platen 105, and in the processes spreading a layer of feed material from the reservoir 120b over the platen 105.

Optionally, the reservoir can include a heater, such as a resistive heater embedded in the support plate 122 or a lower lamp array 126 below the support plate 122, to heat the support plate and the feed material 130 that is in the reservoir 120 above the support plate 122. The lower lamp array can be digitally addressed to permit heating of selective areas or independent control of heating to different areas to permit more uniform heating during the fabrication and cool down processes.

Alternatively or in addition to any heater in or below the support plate 122, in some implementations, the system 100 can include a heat source to heat the side walls 124, e.g., a resistive heater embedded in the side walls, to heat the powder in the reservoir.

Alternatively or in addition to any heater in or below the support plate 122, in some implementations, the system 100 can include a heat source 135 positioned to apply heat radiatively to the feed material 130 in the reservoir 120. The heat source 135 can be positioned so that it does not supply heat to the layer of feed material over the platen 105. The heat source 135 can be a heat lamp, e.g., an IR lamp 135. In implementations with two or more reservoirs 120a, 120b, an IR lamp 135 can be placed above each reservoir.

In operation, the total heat from the heat source 135 and/or heater in or below the support plate 122 is sufficient to raise the temperature of the feed material 130 to a first temperature above room temperature, i.e., above 30° C., but below a threshold temperature, also referred to as a “free flowing temperature,” above which the powder becomes tacky or viscous. This permits the feed material to be dispensed over the platen at an elevated temperature, thus reducing the temperature variation needed for sintering and the power needed by other heating components, but without interfering with the dispensing process. For example, the feed material, e.g., powdered titanium, can be raised to a temperature of 50° C. to 500° C.

Tackiness should be accompanied by morphology change (e.g. necking among the particles), and high resolution imaging equipment could be employed to detect such topographical images. Fractal analysis of the images could also be used to detect tackiness.

In some embodiments, rather than a roller or blade to push the feed material from a reservoir, the dispenser can be positionable above the platen 105 and include a plurality of openings through which one or more feed materials can be deposited on the platen. The dispenser can eject the feed material through the opening. For example, the dispenser can deliver powder particles in a carrier fluid, e.g. a high vapor pressure carrier, to form the layers of powder material. The carrier fluid can evaporate prior to the fusing step for the layer.

A heater can be embedded in the dispenser to heat the powder to the first temperature, or the carrier fluid can be heated to heat the powder to the first temperature.

As noted above, the feed material 130 can be solidified by being raised to a sufficient temperature (and then being cooled if necessary, e.g., to solidify a liquefied feed material). For example, in the case of a powder, the powder can be sintered when heated to a sintering temperature. The temperature of the feed material 130 can be raised to the fusing temperature by heating the feed material 130 by one or more energy sources. The temperature of the feed material can be changed from the room temperature to the sintering temperature by one or more energy sources that heat the feed material in succession.

For example, the feed material can be heated to a first temperature, below the “free flowing temperature” before being deposited onto the platen. Optionally however, the feed material is not heated before being deposited on the platen.

Once deposited on the platen, the entire layer of deposited feed material can be heated or further heated. The deposited feed material can be heated to a third temperature that is at or above the “free flowing temperature.” The layer of feed material can be spread uniformly, e.g., by a roller or blade, before being raised to the third temperature. Alternatively, for some processes, although the feed material may be somewhat tacky, it may still be possible to spread the feed material. In this case, the layer of feed material can be spread uniformly, e.g., by a roller or blade, after being raised to the third temperature that is below the caking temperature.

After being uniformly spread over the platen or underlying layer, the entire layer of feed material can be raised to the “caking temperature.” For some processes, although the feed material can have a cake-like composition, it may still be possible to compress the feed material. In this case, the layer of feed material can be compressed, e.g., by a roller, after being raised to the third temperature that is below the temperature at which the feed material fuses.

Finally, the deposited feed material can be selectively heated to the fusing temperature, e.g., the sintering temperature.

The temperature of the top layer of the feed material deposited on the platen 105 can be raised from the first temperature to or above the “free flowing temperature,” the “caking temperature” or the “fusing temperature” (e.g., the melting temperature or sintering temperature) by supplying heat to it by one or more energy sources.

As noted above, the support can optionally include a heater, such as a resistive heater embedded in the platen 105 or a lower lamp array 109a below the platen or alongside the walls, to heat the platen and the feed material 130 that has been deposited on the platen 105.

Alternatively or in addition to any heater in or below the platen 105, in some implementations, the system 100 can include a first heat source 155 positioned to apply heat radiatively to the feed material 130 on the platen 105. For example, the first heat source 155 can include a plurality of heat lamps 155a-155e positioned above the platen 105 and around the second heat source 160. This permits heating of the entire layer of feed material without interference by the scanning beam heat source.

The heat lamps 155a-e can located above the platen 105 in a circular configuration, e.g., at equal radial distances from the second heat source 160. In addition, the heat lamps 155a-155e can be positioned at equal angular intervals around the second heat source 160. The heat lamps can be oriented at an angle relative to normal to the top surface of the platen 105. This permits the heat from the lamps 155a-155e to reach the portion of the layer of feed material located below the second heat source 160. In the embodiment illustrated in FIG. 2, the second heat source 155 includes five heat lamps, but a different number of lamps could be used.

The different heat lamps might radiate heat non-uniformly. This can result in a non-uniform temperature distribution at the top layer of the feed material. However, a more uniform temperature distribution at the top layer of the deposited feed material can be obtained if the heat lamps 155a-155e are moved such that the various portions of the top layer of the deposited feed material receive radiation from each heat lamp in succession. For example, the heat lamps 1551a-155e can be moved in a circular path around the second heat source 160.

For example, the heating lamps 155a-155e can be suspended from a rotatable support 150. A motor can rotate the support 150 so that the lamps 155a-155e orbit about a vertical central axis 157. The central axis 157 can pass through a center of the platen 105. Similarly, the central axis 157 can pass through the second heat source 160. Causing the heat lamps 155a-155e to move in the circular path that improve the temperature uniformity of the topmost layer of the deposited feed material. The heating rate can be controlled indirectly by a combination of rotational speed and power applied to each lamp.

Alternatively or in addition to any heater in or below the platen 105, in some implementations, the system 100 can include a heat source to heat the side walls 124 surrounding the platen 105, e.g., a resistive heater embedded in the side walls 124, so as to heat the feed material on the platen 105.

As noted above, in order to solidify the desired portions of the deposited feed material, its temperature needs to be raised, e.g., to a sintering temperature for a powder. If the temperature of the layer of feed material 130 over the platen 105 is at the caking temperature, additional energy sources, e.g., the second heat source 160, is used to heat the feed material to the sintering temperature.

The second heat source 160 can be, for example, a laser to generate a laser beam 175. Alternatively, the second heat source 160 can an electron source to generate an electron beam 175 or a plasma point source, e.g., plasma arc The beam 175 can scan over the layer of feed material, the power of the beam can be modulated to selectively fuse, e.g., sinter, portions of the layer of feed material.

By preheating the layer of feed material prior to depositing the layer and/or with the first heat source 155, the amount of power needed by the scanning beam 175 to cause a portion of the layer of feed material to solidify can be reduced. This permits the beam 175 to move more quickly across the layer, and thus can increase throughput. In addition, this can reduce the spatial temperature fluctuations across the layer, and thus reduce thermal stress and improve material properties.

The second heat source 160 includes a beam source 170 and an actuation system 165. The actuation system 165 can translate the beam 176 in the x-y plane relative to the platen 105. As a result, the laser beam 175 can scan the top surface of the feed material. For example, the platen 105 can be held in a fixed position and the beam source 170 can be moved, e.g., by a pair of linear actuators configured to move the beam source 170 in two perpendicular directions. Alternatively, the beam source 170 can be held in a fixed position and the platen 105 can be moved, e.g., by a pair of linear actuators configured to move the beam source 170 in two perpendicular directions. Alternatively, the platen can be moved in one direction by a first linear actuator, and the platen can be moved in a perpendicular direction by a second linear actuator. In any of the above implementations, the beam 175 can be maintained in an orientation normal to the surface of the platen 105 as the beam scans across the layer of feed material. As yet another possibility, the beam 175 can be deflected at a controllable angle in two directions. As still another possibility, either the beam source 170 or platen 105 can be moved along a first direction, and the beam 175 can be controllably deflected to control along a second direction.

Optionally, the actuation system 165 can be configured to also translate the beam source 170 in the Z direction which can allow the control of the shape of the spot size of the beam 175 on the top layer of the feed material.

FIGS. 1 and 2 illustrate the side view and top view respectively in which the second heat source 160 is a laser system. The actuation system 165 includes an optical system that is sometimes referred to as mirror galvanometer, or simply “galvo”. The laser beam 175 emitted by the laser source 170 can be reflected or refracted by the optical elements in the galvo. The optical elements, for example mirrors and lenses, in the galvo, can be attached to mounts that can translate or rotate the optical elements. The mounts and the actuator 165 can be controlled by a computer that may be located outside the additive manufacturing system 100. By changing the orientation of the optical elements in the galvo, the orientation and properties of the laser beam 175 that impinges on the deposited feed material can be changed. For example, the orientation of the optical element can determine the position on the top surface of the feed material at which the laser beam 175 will impinge.

In addition, the beam source 160 can include optical components 167 to control the depth of focus and/or the spot size of the laser beam 175 on the top surface of the feed material. Therefore, the actuator 165 and the galvo can control the position and the spot size of the laser beam on the top surface of the feed material.

The spot size plays an important role in the sintering process. The larger the spot size, the lower the resolution of the fusing process. However, the larger the spot size, the less time required to scan across the layer of feed material. For a given power, the spot size can also determine the intensity of the laser beam on the top surface of the deposited feed material. For example, for a laser source 170 with a given output power, the spot size is inversely proportional to the laser beam intensity. If the intensity of the laser beam decreases, the heat energy transferred to a unit area of the feed material that is illuminated by the laser beam also decreases. Similarly, increasing the intensity of the laser beam impinging on the feed material (by decreasing the spot size) will increase the heat energy transferred to a unit area of the feed material that is illuminated by the laser beam.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a non-transitory machine readable storage medium or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a standalone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network. The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

A number of implementations have been described. However, certain features can be combined for advantageous affect, without including other features. For example, the following combinations are possible:
The temperature of the entire layer of the feed material can be raised to the first temperature (below the free flowing temperature) before the feed material is dispensed, and then the temperature of the layer of feed material can then be selectively increased to the fusing temperature, without raising all of the layer of feed material to the free flowing temperature or caking temperature. In this case, the first heat source can be optional.
The temperature of the entire layer of the feed material on the platen can be raised to or above the free flowing temperature or the caking temperature without deliberately raising the temperature of the feed material before it is dispensed. In this case, the heater for the reservoir can be optional.
After the layer of the feed material has been dispensed, the temperature of all of the layer of feed material can be raised to or above the free flowing temperature, but without raising all of the layer of feed material to the caking temperature.
The lamp array surrounding the second heat source can be used to raise the temperature of the feed material, but not above the caking temperature.
The lamp array surrounding the second heat source can remain stationary rather than rotating.
The lamp array can be positioned above the platen but at a height lower than the energy source while still being considered positioned “around” the energy source.
If the feed material is selectively deposited, e.g., by a dispenser having an array of controllable openings, then the entire layer of feed material can be raised to the fusing temperature simultaneously, e.g., by a lamp array.

In addition, it will be understood that various modifications may be made. Accordingly, other implementations are within the scope of the following claims.

What is claimed is:

1. An additive manufacturing system, comprising:
a platen having a top surface to support an object being manufactured;
a dispenser to deliver a plurality of successive layers of feed material over the platen;
a first heater configured to heat the feed material to a first temperature that is below a temperature at which the powder becomes tacky before the feed material is dispensed by the dispenser; and
an energy source to fuse at least some of an outermost layer of feed material over the platen.

2. The system of claim 1, wherein the dispenser comprises a reservoir adjacent the platen.

3. The system of claim 2, wherein the first heater comprises a heat lamp positioned above the reservoir.

4. The system of claim 2, wherein the first heater comprises a resistive heater embedded in a support plate or a side wall of the reservoir.

5. The system of claim 2, wherein the first heater is configured to heat the feed material in the dispenser without applying heat to the layer of feed material dispensed over the platen.

6. The system of claim 2, wherein the dispenser comprises two reservoirs positioned on opposite sides of the platen.

7. The system of claim 1, comprising a second heater configured to heat substantially all of the outermost layer to a caking temperature.

8. The system of claim 7, wherein the second heater comprises a plurality of heat lamps positioned around the energy source.

9. The system of claim 7, wherein the second heater comprises a resistive heater embedded in a side wall surrounding the platen.

10. The system of claim 1, wherein the energy source comprises a laser or an ion source.

11. A method of additive manufacturing, comprising:
before dispensing a feed material in a layer over platen, raising a temperature of the feed material to a first temperature that is above room temperature and below a second temperature at which the feed material becomes tacky;
dispensing the feed material at the first temperature in a layer over the platen;
after dispensing the feed material over the platen, raising the temperature of substantially all of the layer of feed material to a third temperature that is less than a fourth temperature at which the feed material fuses; and
selectively raising the temperature of portions of the layer of feed material to a fifth temperature that is equal or greater than a fourth temperature at which the feed material fuses.

12. The method of claim 11, wherein the third temperature is greater than the second temperature.

13. The method of claim 11, wherein selectively raising the temperature of portions of the layer of feed material to the fifth temperature is performed with a laser or ion source.

14. The method of claim 13, wherein raising the temperature of substantially all of the layer of feed material to the third temperature is performed with a plurality of heat lamps.

15. The method of claim 11, wherein raising the temperature of the feed material to the first temperature comprises raising the temperature of the feed material while the feed material is in a reservoir.

16. The method of claim 15, wherein raising the temperature of the feed material while the feed material is in a reservoir comprises heating the feed material with a resistive heater embedded in a support plate of the reservoir.

17. The method of claim 5, wherein raising the temperature of the feed material while the feed material is in a reservoir comprises heating the feed material with a heat lamp positioned over the reservoir.

18. The method of claim 11, wherein the feed material comprises a powder and the fourth temperature comprises a sintering temperature.

19. An additive manufacturing system, comprising:
a platen having a top surface to support an object being manufactured;
a dispenser to deliver a plurality of successive layers of feed material over the platen at a first temperature that is less than a second temperature at which the feed material becomes tacky;
a first heater configured to heat at least a portion of the layer of feed material over the platen to a third temperature that is at or above the second temperature and below a fourth temperature at which the feed material fuses; and
an energy source to selectively fuse at least some of an outermost layer of feed material over the platen.

20. A method of additive manufacturing, comprising:
dispensing the feed material at a first temperature that is below a second temperature at which the feed material becomes tacky in a layer over the platen;
after dispensing the feed material over the platen, raising the temperature of at least a portion of the layer of feed material to a third temperature that is above the second temperature and below than a fourth temperature at which the feed material fuses; and
selectively fusing at least some of an outermost layer of feed material over the platen.
